(19) United States
(12) Patent Application Publication
(10) Pub. No.: US 2003/0102801 A1
(43) Pub. Date: Jun. 5, 2003

(54) Lighting device with a reflecting layer and liquid crystal display device

(76) Inventor: Shigeru Senbonmatsu, Chiba-shi (JP)

Correspondence Address: ADAMS & WILKS, 31st Floor, 50 Broadway, New York, NY, 10004, US

(21) Appl. No.: 10/290,951

(22) Filed: Nov. 8, 2002

(30) Foreign Application Priority Data
Nov. 9, 2001 (JP) 2001-345246

(51) Int. Cl. H05B 33/22

(52) U.S. Cl. 313/506

(57) ABSTRACT

In order to reduce drive power of a lighting device for liquid crystal display, the lighting device is composed of a semi-transmission reflecting layer in which a reflection portion and a transmission portion are formed and a light emitting element formed to a region corresponding to the transmission portion, and light emitted from the light emitting element is outputted through the transmission portion.

### BACKGROUND OF THE INVENTION

1. Field of the Invention

The present invention relates to a lighting device with a reflecting layer which is suitable to various lightings, such as a backlight of a liquid crystal panel and a liquid crystal display device provided therewith, and more particularly to a semi-transmission type liquid crystal display device which combines a transmission mode with a reflection mode.

2. Description of the Related Art

A liquid crystal display device has various advantages such as low power consumption, low voltage drive, weight reduction, and flat display. Thus, in recent years, it is used as a display device for an electronic device in many cases. As commonly used liquid crystal display devices, there are a TN liquid crystal type and an STN liquid crystal type. With respect to a method of driving a liquid crystal panel, static drive or active matrix drive using TFT elements or TFD elements is employed for the TN liquid crystal. In addition, passive matrix drive is employed for the STN liquid crystal.

The liquid crystal panel is not a self-luminous device and serves as a shutter. Thus, any light source is required for viewing its display. A method of utilizing a light source is roughly divided into two types (transmission type and reflection type). The transmission type is a type using an auxiliary light source such as a backlight. The reflection type is a type using a fluorescent lamp, sunlight, or the like as a light source. In addition, in recent years, a semi-transmission liquid crystal type which combines the transmission type with the reflection type is generally used as a portable information terminal.

FIG. 26A shows a transmission type. A liquid crystal panel 400 is observed using a backlight 402 as a light source. In this type of liquid crystal display device, an image quality is good. However, there is a problem in that power consumption is large and it is hard to view a liquid crystal panel when intense light is made incident upon the front surface thereof in direct sunlight or the like to receive regular reflection light.

FIG. 26B shows a total reflection type liquid crystal display device. The liquid crystal panel 400 is observed using external light reflected by a total reflecting layer 406. According to this type, power consumption is low and it is particularly easy to view a liquid crystal panel when intense regular reflection light is made incident upon the entire surface thereof in direct sunlight or the like. However, there is a problem in that display is hard to be viewed because it is dark in a weak light source in the room and display cannot be completely viewed in the nighttime.

FIG. 26C shows a semi-transmission type liquid crystal display device. A semi-transmission reflecting layer 408 is provided between the liquid crystal panel 400 and the backlight 402. According to the liquid crystal display device, in the location where external light can be utilized, it can be used in a reflection mode. Thus, the backlight 402 can be turned off, thereby being capable of saving the power. In addition, if the backlight 402 is turned on, display can be viewed even in a dark location. However, when the backlight 402 is turned on, absorption and reflection of the backlight light by the semi-transmission reflecting layer 408 are produced. Thus, when a surface luminance equal to that of the display device having the structure shown in FIG. 26A is obtained on the entire surface of the liquid crystal display device, there is a problem in that the power consumption of this type becomes largest.

FIG. 27A shows a transmission mode of the semi-transmission type liquid crystal display device. As described above, backlight light 404 from the backlight 402 is attenuated while it passed through the semi-transmission reflecting layer 408, and then reaches the liquid crystal panel 400.

FIG. 27B shows a reflection mode. With respect to the semi-transmission reflecting layer 408, there are generally two types, a type in which a through hole is provided in a reflecting layer and a type in which a ratio of transmission and reflection is controlled by thinning a reflecting film. A ratio of reflection and transmission in the semi-transmission reflecting layer 408 can be arbitrarily designed by an optical design of a liquid crystal and a product specification.

FIGS. 28A to 28B show a holed type semi-transmission reflecting layer 412. A large number of holes 416 are formed in a reflecting layer 414 such as a total reflection mirror of an alloy/dielectric multi-layer film which contains Ag/Al/Ag or Al and has a thickness of 100 nm to 200 nm. The holes 416 are used for light transmission portions and other portions are used as reflection portions. In addition, a protective film made of SiO₂ or the like is laminated on the top surface of such a semi-transmission reflecting layer if necessary.

For example, in the case of a semi-transmission reflecting layer for which transmission is important (it is relatively dark in a reflection mode and light in a transmission mode) as shown in FIG. 28A, the following structures can be demonstrated.

(1) Random arrangement in the case of the percentage of holes of 20% to 40% and a circular shape with a diameter of 10 μm.

(2) Random arrangement in the case of the percentage of holes of 20% to 40% and circular shapes with diameters of 10 μm and 15 μm.

(3) Random arrangement in the case of the percentage of holes of 20% to 40% and a square shape with a diagonal length of 10 μm.

In addition, a shape and a size of an opening portion can be arbitrarily designed so as not to cause moiré according to an electrode design for a liquid crystal panel.

Also, in the case of a semi-transmission reflecting layer for which reflection is important (it is relatively light in a reflection mode and dark in a transmission mode) as shown in FIG. 28B, the following structures can be demonstrated.

(1) Random arrangement in the case of the percentage of holes of 10% to 20% and a circular shape with a diameter of 10 μm.

(2) Random arrangement in the case of the percentage of holes of 10% to 20% and circular shapes with diameters of 10 μm and 15 μm

(3) Random arrangement in the case of the percentage of holes of 10% to 20% and a square shape with a diagonal length of 10 μm.

In addition, a shape and a size of an opening portion can be arbitrarily designed so as not to cause moiré according to an electrode design for a liquid crystal panel.

Next, a non-holed type semi-transmission reflecting layer will be described. According to this type of semi-transmission reflecting layer, a ratio of transmission and reflection of light is controlled by a thickness of the semi-transmission reflecting layer. The semi-transmission reflecting layer can be formed from Al, Ag, or an alloy containing Al or Ag. An optical design using a dielectric multi-layer film mirror is also possible. FIGS. 29A to 29C show a non-holed type semi-transmission reflecting layer. FIG. 29A shows an example of a semi-transmission reflecting layer 408 for which transmission is important. According to this reflecting layer, it is relatively dark in a reflection mode and light in a transmission mode. For example, when a thickness of an Al semi-transmission reflecting layer is 20 nm, its transmittance becomes 15% and its reflectance becomes 67%. FIG. 29B shows an example of a semi-transmission reflecting layer 408 for which reflection is important. According to this reflecting layer, it is relatively light in a reflection mode and dark in a transmission mode. For example, when a thickness of an Al semi-transmission reflecting layer is 40 nm, its transmittance becomes 3% and its reflectance becomes 17%. FIG. 29C shows an example of a total reflecting layer 418 for reference. This reflecting layer has only a reflection mode. For example, when a thickness of an Al semi-transmission reflecting layer is 150 nm, its transmittance becomes 0% and its reflectance becomes 85%.

According to the liquid crystal display device, power consumption is smaller than that of other display devices. Thus, it is in common use as a display device such as a portable electronic device. In many cases, a battery is used as a power source of the portable electronic device. Therefore, low power consumption makes extreme important sense.

Also, in the case of a portable information device, a reflection mode is effective because of the requirement of low power consumption and it can be used in daylight outdoors or in the indoors where lighting exists. However, it is required that the portable information device can be used even in nighttime outdoors or in the dark indoors because of its characteristic. Thus, it is essential to have a transmission mode using an auxiliary light source such as a backlihgt. Therefore, a semi-transmission type liquid crystal display device which combines both modes is generally utilized as a portable device. According to a conventional semi-transmission type liquid crystal display device, light absorption by the semi-transmission reflecting layer is produced in a transmission mode. Thus, there is a problem in that power consumption is greatly increased as compared with the case of the reflection mode.

### SUMMARY OF THE INVENTION

The present invention has been made in view of the above, and an object of the present invention is therefore to provide a lighting device having low power consumption, more particularly, a lighting device which can be incorporated in a liquid crystal display device and the like and has low power consumption, and a liquid crystal display device in which the lighting device is incorporated.

According to one aspect of the present invention, there is provided a lighting device with a reflecting layer including: a semi-transmission reflecting layer in which a reflection portion and a transmission portion are formed; and a light emitting element formed to a region corresponding to the transmission portion, characterized in that light emitted from the light emitting element is outputted through the transmission portion.

According to another aspect of the present invention, there is provided a lighting device, in which the light emitting element is an EL element, and only the EL layer in a location corresponding to the transmission portion of the semi-transmission reflecting layer emits light. Alternatively, the EL layer is formed in only a location corresponding to the transmission portion of the semi-transmission reflecting layer. Or, it is structured such that at least one of the anode layer and the cathode layer for applying voltage to the EL layer is not formed in a location corresponding to the reflection portion. Alternatively, an insulating layer is formed between at least one of the anode layer and the cathode layer and the EL layer in a location corresponding to the reflection portion.

According to another aspect of the present invention, there is provided a liquid crystal display device including: a liquid crystal panel; and a lighting device provided on a rear surface of the liquid crystal panel, characterized in that the lighting device includes, a semi-transmission reflecting layer in which a reflection portion and a transmission portion are formed, and a light emitting element formed to a region corresponding to the transmission portion, and that light emitted from the light emitting element is outputted through the transmission portion and irradiated to the liquid crystal panel. Further, in the liquid crystal display device, the light emitting element is an EL element, and only the EL layer in a location corresponding to the transmission portion emits light.

### BRIEF EXPLANATION OF THE DRAWINGS

In the accompanying drawings:

FIG. 1 is an explanatory view showing the structure of a lighting device of the present invention;

FIG. 2 is an explanatory view showing a fundamental structural example of an EL element used for the present invention;

FIG. 3 is an explanatory view showing another fundamental structural example of an EL element used for the present invention;

FIG. 4 is an explanatory view showing a structural example of a liquid crystal display device incorporating a lighting device of the present invention;

FIG. 5 is an explanatory view showing the structure of a lighting device of Embodiment 1;

FIG. 6 is an explanatory view showing the structure of a lighting device of Embodiment 2;

FIG. 7 is an explanatory view showing the structure of a lighting device of Embodiment 3;

FIG. 8 is an explanatory view showing the structure of a lighting device of Embodiment 4;

FIG. 9 is an explanatory view showing the structure of a lighting device of Embodiment 5;

FIG. 10 is an explanatory view showing the structure of a lighting device of Embodiment 6;

FIG. 11 is an explanatory view showing the structure of a lighting device of Embodiment 7;

FIG. 12 is an explanatory view showing the structure of a lighting device of Embodiment 8;

FIG. 13 is an explanatory view showing the structure of a lighting device of Embodiment 9;

FIG. 14 is an explanatory view showing the structure of a lighting device of Embodiment 10;

FIG. 15 is an explanatory view showing the structure of a lighting device of Embodiment 11;

FIG. 16 is an explanatory view showing the structure of a lighting device of Embodiment 12;

FIG. 17 is an explanatory view showing the structure of a lighting device of Embodiment 13;

FIG. 18 is an explanatory view showing the structure of a lighting device of Embodiment 14;

FIG. 19 is an explanatory view showing the structure of a lighting device of Embodiment 15;

FIG. 20 is an explanatory view showing the structure of a lighting device of Embodiment 16;

FIG. 21 is an explanatory view showing the structure of a lighting device of Embodiment 17;

FIG. 22 is an explanatory view showing the structure of a lighting device of Embodiment 18;

FIG. 23 is an explanatory view showing the structure of a liquid crystal display device of Embodiment 19;

FIG. 24 is an explanatory view showing the structure of a liquid crystal display device of Embodiment 20;

FIG. 25 is an explanatory view showing the structure of a liquid crystal display device of Embodiment 21;

FIG. 26A is an explanatory view showing the structure of a conventional transmission type liquid crystal display device, FIG. 26B is an explanatory view showing the structure of a conventional total reflection type liquid crystal display device, and FIG. 26C is an explanatory view showing the structure of a conventional semi-transmission type liquid crystal display device;

FIG. 27A is an explanatory view showing a transmission mode of a conventional liquid crystal display device and FIG. 27B is an explanatory view showing a reflection mode of the conventional liquid crystal display device;

FIG. 28A is an explanatory view showing the structure of a conventional holed type semi-transmission reflecting layer for which transmission is important and FIG. 28B is an explanatory view showing the structure of a conventional holed type semi-transmission reflecting layer for which reflection is important; and

FIG. 29A is an explanatory view showing the structure of a conventional non-holed type semi-transmission reflecting layer for which transmission is important, FIG. 29B is an explanatory view showing the structure of a conventional non-holed type semi-transmission reflecting layer for which reflection is important, and FIG. 29C is an explanatory view showing the structure of a conventional total reflecting layer.

### DETAILED DESCRIPTION OF THE PREFERRED EMBODIMENTS

A lighting device according to the present invention includes a semi-transmission reflecting layer in which reflection portions and transmission portions are formed and a light emitting element in which only regions corresponding to the transmission portions emit light, and is constructed such that light emitted from the light emitting element is outputted through the transmission portions.

Also, a liquid crystal display device according to the present invention has a lighting device which includes a semi-transmission reflecting layer in which reflection portions and transmission portions are formed and a light emitting element formed to regions corresponding to the transmission portions, which is located on the rear surface of a liquid crystal panel, and is constructed such that light emitted from the light emitting element is outputted through the transmission portions and irradiated to the liquid crystal panel.

Hereinafter, the case where an EL element is used as a light emitting element will be described in detail with reference to the drawings.

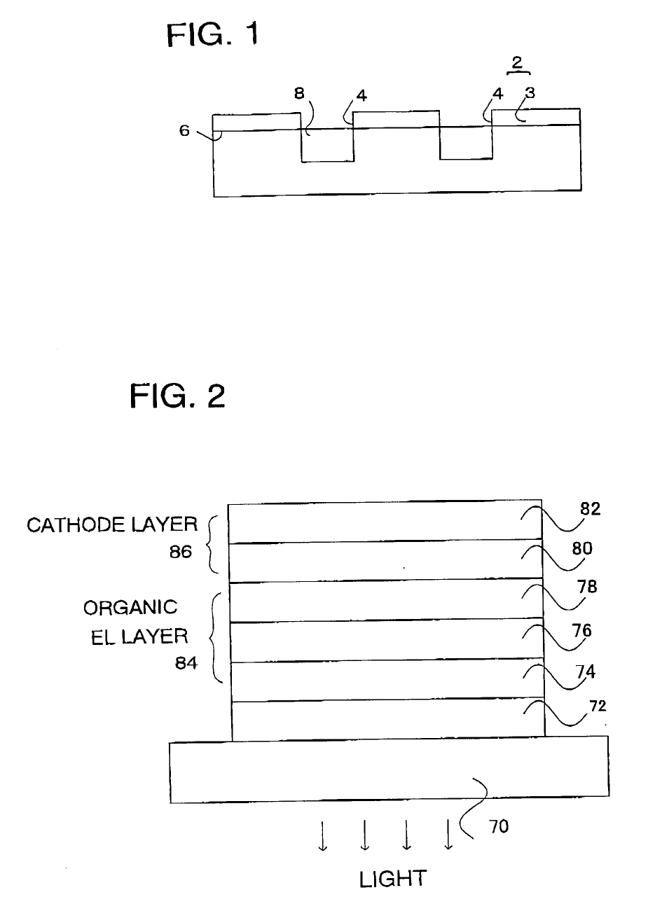

FIG. 1 shows a fundamental structural example of a lighting device with a reflecting layer according to the present invention. As shown in the drawing, with respect to a semi-transmission reflecting layer 2, a large number of through holes 4 are provided in a reflecting layer 3. Respective EL elements 8 are formed corresponding to the respective through holes 4 on the rear surface 6 of the semi-transmission reflecting layer 2 in which the respective through holes 4 are provided. When the EL elements 8 are made to emit light, light is passed through the through holes 4 without being attenuated and irradiated toward the front of the semi-transmission reflecting layer 2. According to the semi-transmission reflecting layer of the present invention, a large number of holes are formed in the reflecting layer such as a total reflection mirror of an alloy dielectric multi-layer film which contains Ag, Al/Ag, or Al and has a thickness of 100 nm to 200 nm. In addition, the holes are used for light transmission portions and other portions are used as reflection portions. A protective film made of SiO₂ or the like is laminated on the top surface of the semi-transmission reflecting layer if necessary.

In the case of a semi-transmission reflecting layer for which transmission is important (it is relatively dark in a reflection mode and light in a transmission mode), the following structures can be demonstrated.

(1) Random arrangement in the case of the percentage of holes of 20% to 40% and a circular shape with a diameter of 10 μm.

(2) Random arrangement in the case of the percentage of holes of 20% to 40% and circular shapes with diameters of 10 μm and 15 μm.

(3) Random arrangement in the case of the percentage of holes of 20% to 40% and a square shape with a diagonal length of 10 μm.

In addition, a shape and a size of an opening portion can be arbitrarily designed so as not to cause moiré according to an electrode design for a liquid crystal panel.

Also, in the case of a semi-transmission reflecting layer for which reflection is important (it is relatively light in a reflection mode and dark in a transmission mode), the following structures can be demonstrated.

(1) Random arrangement in the case of the percentage of holes of 10% to 20% and a circular shape with a diameter of 10 μm.

(2) Random arrangement in the case of the percentage of holes of 10% to 20% and circular shapes with diameters of 10 μm and 15 μm.

(3) Random arrangement in the case of the percentage of holes of 10% to 20% and a square shape with a diagonal length of 10 μm.

In addition, a shape and a size of an opening portion can be arbitrarily designed so as not to cause moiré according to an electrode design for a liquid crystal panel.

The semi-transmission reflecting layer 2 can be formed by known means such as EB evaporation, sputtering, ion plating, or the like using the above material. In addition, the through holes 4 can be formed by known semiconductor element manufacturing means, for example, evaporation using a mask, dry etching, or the like.

In the lighting device with the reflecting layer according to the present invention, as the structure described above, a large number of through holes are formed in the reflecting layer. In addition, the respective electroluminescent elements (EL elements) are formed in the bottom regions of the respective through holes. Thus, light from the EL elements is passed through the through holes 4 without being attenuated and irradiated toward the front of the semi-transmission reflecting layer. For example, when the present invention is compared with a conventional case with respect to power consumption of a backlight of a liquid crystal display device using a semi-transmission reflecting layer having reflectance of 90% and transmittance of 10% (light absorption is neglected), in the case of the reflection mode, there is justly no difference because the backlight is turned off. However, in the case of display in the transmission mode, power of the backlight required for obtaining an equal brightness in the liquid crystal display device according to the present invention theoretically becomes 1/10 times smaller than that in the conventional case. Table 1 shows a comparison related to power consumption of the backlight and the like between the conventional case and the present invention.

TABLE 1

| | | Conventional | Present |
|---|---|---|---|
| | | product | Invention |
| Surface average intensity of | cd/m² | 1000 | 100 |
| backlight | | | |
| Surface average intensity after light | cd/m² | 100 | 100 |
| transmits semi-transmission | | | |
| reflecting layer | | | |
| Intensity of emission point | cd/cm² | 1000 | 1000 |
| voltage | V | 3.5 | 3.5 |
| Consumption electric current | MA | 50 | 5 |
| Power consumption | mW | 175 | 17.5 |
| Remarks | | Total light | Part light |
| | | emission | emission |

Fixed Condition

(1) Assume that a semi-transmission reflecting layer (10% in transmittance and 90% in reflectance) is a holed type and no light absorption is caused.

(2) Transmittance of a liquid crystal panel is 10%.

(3) Assume that the liquid crystal panel and the backlight each have an area of 10 cm².

(4) Estimation is conducted in the case where no external light is present and the backlight is turned on.

(5) Assume that a surface intensity of the liquid crystal panel when the backlight is turned on is 10 cd/cm².

(6) An organic EL element having light emitting characteristics of 1000 cd/cm², 3.5 V, and 5 mA/cm² is used as the backlight.

An inorganic EL element or an organic EL element can be used as the EL element. A dispersion type inorganic EL element or a thin film type inorganic EL element can be illustrated as an example of the inorganic EL element. In addition, a low molecular organic EL element, a polymer organic EL element, or the like can be illustrated as an example of the organic EL element.

Of them, the low molecular organic EL element is more preferable because of easy manufacturing, a low operating voltage, and the like.

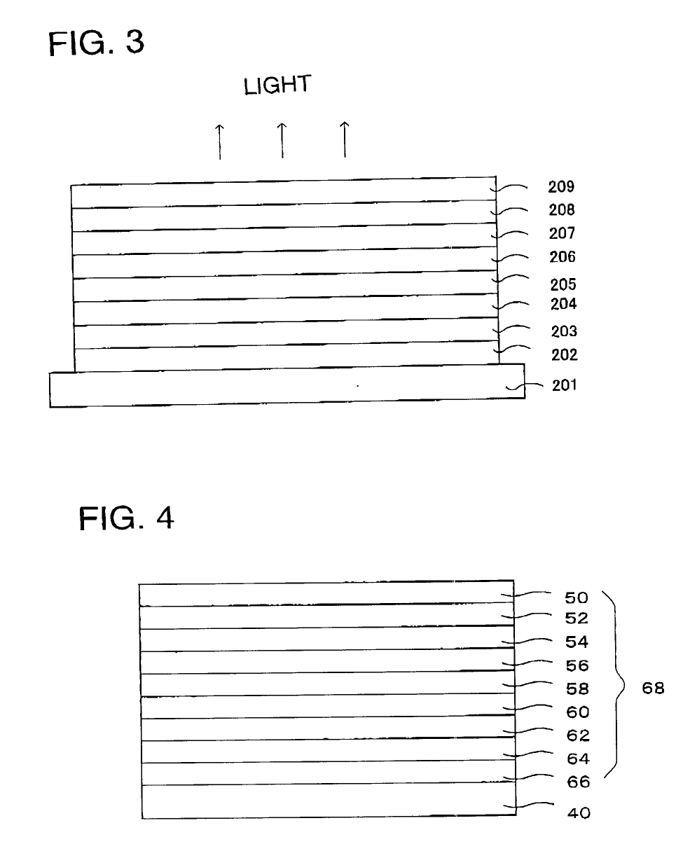

The organic EL element can be divided into two types according to light emitting methods. That is, there are a type for emitting light from an anode layer side as illustrated in FIG. 2 and a type for emitting light from a transparent cathode side as illustrated in FIG. 3.

FIG. 2 is a schematic view showing an example of the structure of a low molecular organic EL element. In FIG. 2, a transparent substrate 70 is a polished substrate made of no alkali glass or the like and its thickness is preferable to be 0.1 mm to 1.1 mm. A transparent electrode 72, a hole injection layer 74, a hole transporting layer 76, a light emitting layer 78, a first cathode layer 80, and a second cathode layer 82 are laminated in order on the transparent substrate 70. An organic EL layer 84 is composed of the hole injection layer 74, the hole transporting layer 76, and the light emitting layer 78. In addition, a cathode layer 86 is composed of the first cathode layer 80 and the second cathode layer 82. Note that, as described above, an anode layer is composed of the transparent electrode 72. The organic EL element emits light from the anode layer side by the application of a direct current voltage.

Here, it is preferable that the transparent electrode (anode layer) 72 is made of indium tin oxide (ITO) formed by sputtering or the like, indium oxide doped with tin, or the like, and its thickness is 100 nm to 200 nm. It is preferable that the hole injection layer 74 is obtained by forming for example CuPc (copper phthalocyanine) at about 30 nm to 100 nm by evaporation or the like. It is preferable that the hole transporting layer 76 is obtained by laminating for example α-NPD (α-naphthylphenyldiamine) at 10 nm to 40 nm by evaporation or the like. It is preferable that the light emitting layer 78 is obtained by laminating for example Alq₃ (8-quinolinol aluminum complex) at 10 nm to 40 nm by evaporation or the like. It is preferable that the first cathode layer 80 is obtained by laminating for example LiF (lithium fluoride) at 0.1 nm to 2 nm by evaporation. It is preferable that the second cathode layer 82 is obtained by laminating Al (aluminum) at 100 nm to 200 nm by evaporation.

FIG. 3 is a schematic view showing another example of an organic EL element which can be used for the present invention. In FIG. 3, as a substrate 201, any polished smooth insulating plate made of no alkali glass or the like can be used. It is not required that the substrate is transparent. Its thickness is preferably about 0.5 mm to 1.1 mm. A reflecting layer 202, a transparent electrode 203, a hole injection layer 204, a hole transporting layer 205, a light emitting layer 206, a first transparent cathode layer 207, a second transparent cathode layer 208, and a third transparent cathode layer 209 are laminated on the transparent substrate 201. A transparent cathode is composed of the first to third transparent cathode layers 207 to 209. In addition, an organic EL layer is composed of the hole injection layer 204, the hole transporting layer 205, and the light emitting layer 206. In addition, a cathode layer 86 is composed of the first cathode layer 80 and the second cathode layer 82. Note that the transparent electrode 203 composes an anode layer. The organic EL element emits light from the transparent cathode layer side. Here, it is preferable that the reflecting layer 202 is made of silver, aluminum, or the like and its thickness is 100 nm to 200 nm. A dielectric multi-layer film reflecting mirror or the like can be also used. It is preferable that the anode layer 203 made from the transparent electrode is made of ITO, indium oxide doped with tin, or the like, and its thickness is 100 nm to 200 nm. It can be formed by sputtering or the like. The hole injection layer 204 can be formed by evaporation using CuPc (copper phthalocyanine) or the like. Its thickness is preferably 30 nm to 100 nm. The hole transporting layer 205 can be formed by evaporation using α-NPD (α-naphthylphenyldiamine) or the like. Its thickness is preferably 10 nm to 40 nm. The light emitting layer 206 can be formed by evaporation using Alq₃ (8-quinolinol aluminum complex) or the like. Its thickness is preferably 10 nm to 40 nm. The first transparent cathode layer 207 can be formed by evaporation using LiF (lithium fluoride) or the like. Its thickness is preferably 0.1 nm to 2 nm. The second transparent cathode layer 208 can be formed by evaporation using Al (aluminum) or the like. Its thickness is preferably 5 nm to 10 nm. The third transparent cathode layer 209 can be formed by for example sputtering using ITO, indium oxide doped with tin, or the like. Its thickness is preferably 100 nm to 200 nm.

With respect to the organic EL element, in addition to the above structures shown in FIGS. 2 and 3, there are various structures such as (1) a structure in which an anode, a light emitting layer, and an cathode are laminated, (2) a structure in which an anode, a hole transporting layer, a light emitting layer, an electron transporting layer, and an cathode are laminated, (3) a structure in which an anode, a light emitting layer, an electron transporting layer, and an cathode are laminated, and (4) a structure in which an anode, a hole transporting layer, a light emitting layer, and an cathode are laminated. According to the present invention, the structures of conventional various organic EL elements can be used without modification. In addition, In the present invention, the organic EL element for green light emission is used. However, when a light emitting material or the like is changed, various light emitting colors which have been proposed up to now can be also used.

With respect to a liquid crystal display device of the present invention, the lighting device with the reflecting layer having the above structure is overlapped with a known liquid crystal panel and the lighting device is used as a backlight. FIG. 4 shows a schematic structure of a liquid crystal display device of the present invention. As shown in the drawing, a lighting device 40 is overlapped with a liquid crystal panel 68. In the liquid crystal panel 68, liquid crystal 58 is sealed between transparent substrates 52 and 64 in which indium tin oxide (ITO) films 54 and 62 and alignment films 56 and 60 are provided respectively, and polarizing plates 50 and 60 are provided to sandwich them.

For the sake of simplifying the drawing, various optical films, a liquid crystal seal, and the like are omitted here, and a TN liquid crystal monochrome type which is most simple is described as an example. In the liquid crystal display device with the reflecting layer according to the present invention, in addition to the above examples, the lighting device can be combined with various liquid crystal panels such as a TFT liquid crystal panel and an STN liquid crystal panel which have been proposed up to now.

Hereinafter, the present invention will be described more specifically in accordance with embodiments.

(Embodiments 1 to 8)

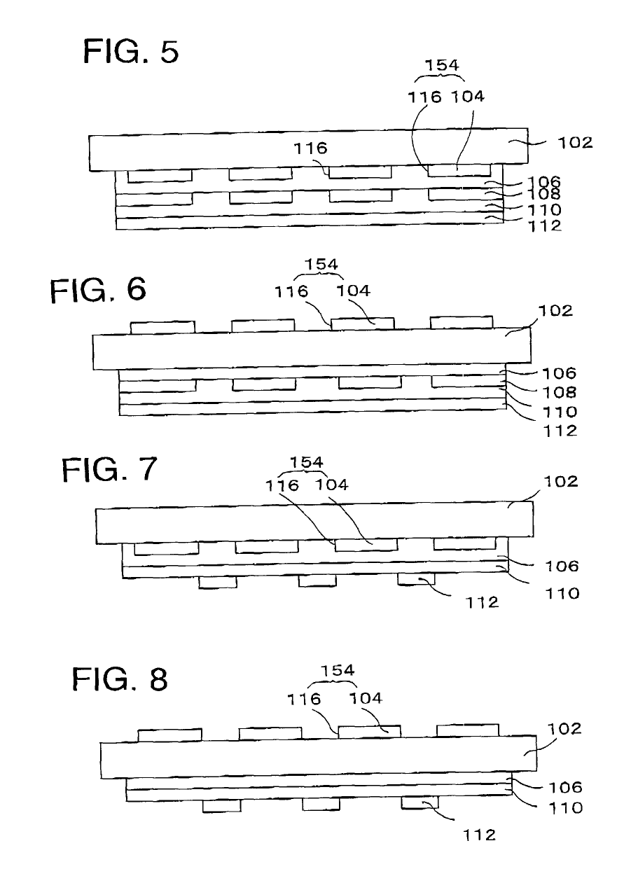

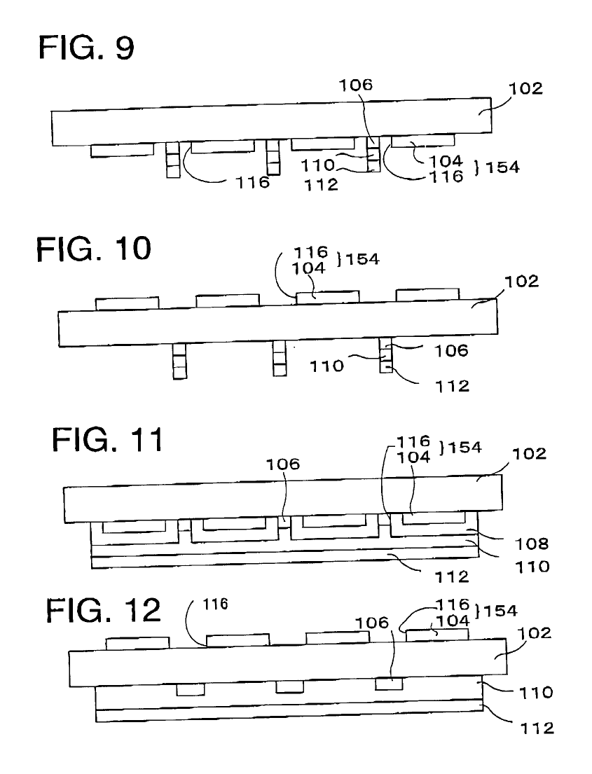

FIGS. 5 to 12 show the structures of lighting devices to which a method of emitting light from an anode layer side (organic EL element illustrated in FIG. 2) is applied. Meanings of reference symbols in the respective drawings are indicated in the following tables 2 and 3.

TABLE 2

| | | | | Example | | | |
|---|---|---|---|---|---|---|---|
| | | | | 1 | 2 | 3 | 4 |
| | Composition | Thickness | | | | | |
| Substrate | Transparent substrate | 0.1-1.1 | mm | 102 | 102 | 102 | 102 |
| Anode layer | Transparent electrode | 100-200 | nm | 106 | 106 | 106 | 106 |
| Organic EL layer | Hole injection layer | 30-100 | nm | 110 | 110 | 110 | 110 |
| | Hole transporting layer | 10-40 | nm | 110 | 110 | 110 | 110 |
| | Light emitting layer | 10-40 | nm | 110 | 110 | 110 | 110 |
| Cathode layer | First cathode layer | 0.1-2 | nm | 112 | 112 | 112 | 112 |
| | Second cathode layer | 100-200 | nm | 112 | 112 | 112 | 112 |
| Insulating layer | Insulating layer | 100-200 | nm | 108 | 108 | None | None |
| Reflecting layer | Reflecting layer | 100-200 | nm | 104 | 104 | 104 | 104 |

TABLE 3

| | | | | Example | | | |
|---|---|---|---|---|---|---|---|
| | | | | 5 | 6 | 7 | 8 |
| | Composition | Thickness | | | | | |
| Substrate | Transparent substrate | 0.1-1.1 | mm | 102 | 102 | 102 | 102 |
| Anode layer | Transparent electrode | 100-200 | nm | 106 | 106 | 106 | 106 |
| Organic EL layer | Hole injection layer | 30-100 | nm | 110 | 110 | 110 | 110 |
| | Hole transporting layer | 10-40 | nm | 110 | 110 | 110 | 110 |
| | Light emitting layer | 10-40 | nm | 110 | 110 | 110 | 110 |
| Cathode layer | First cathode layer | 0.1-2 | nm | 112 | 112 | 112 | 112 |
| | Second cathode layer | 100-200 | nm | 112 | 112 | 112 | 112 |
| Insulating layer | Insulating layer | 100-200 | nm | None | None | 108 | None |
| Reflecting layer | Reflecting layer | 100-200 | nm | 104 | 104 | 104 | 104 |

In the drawings, a polished transparent substrate made of no alkali glass or plastic is used as a substrate 102. A reflecting layer 104 is a reflecting layer made of aluminum, silver, or the like. A dielectric multi-layer film total reflection mirror or the like can be also used. An anode layer 106 is an ITO film formed by sputtering or the like. For an insulating layer 108, SiO₂, SiN, SiNxOy, or the like is used.

An organic EL layer 110 is composed of a hole injection layer, a hole transporting layer, a light emitting layer, and the like. The hole injection layer can be formed by evaporation using CuPc (copper phthalocyanine) or the like. The hole transporting layer can be formed by for example an evaporation method using α-NPD (α-naphthylphenyldiamine) or the like. The light emitting layer can be formed by for example evaporation using Alq₃ (8-quinolinol aluminum complex) or the like.

A cathode layer 112 is composed of a first cathode layer, a second cathode layer, and the like. The first cathode layer can be formed by for example evaporation using LiF (lithium fluoride) or the like. The second cathode layer can be formed by for example evaporation using aluminum or the like.

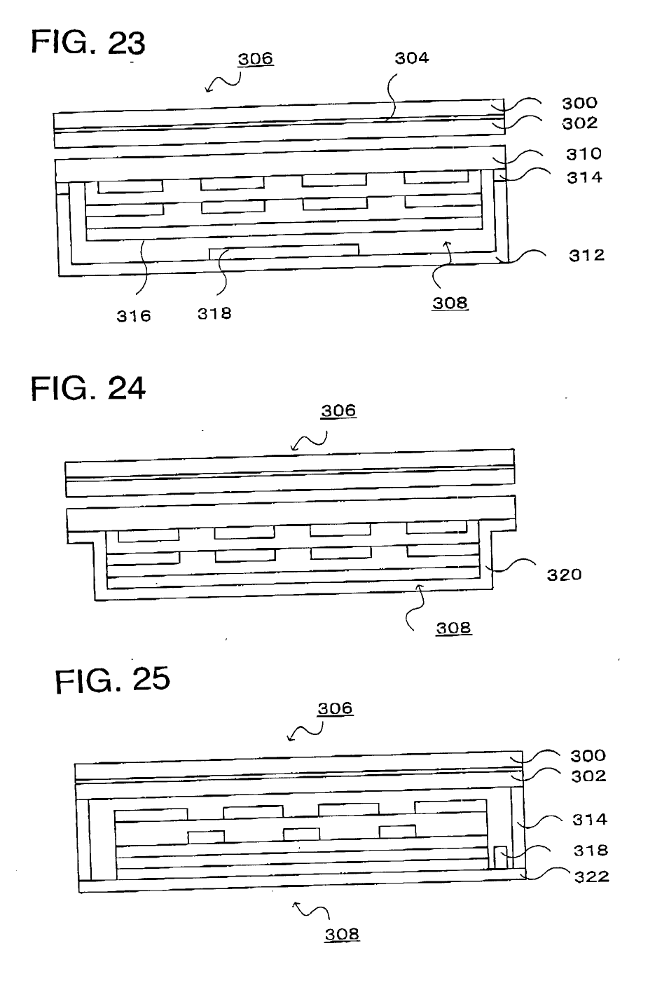

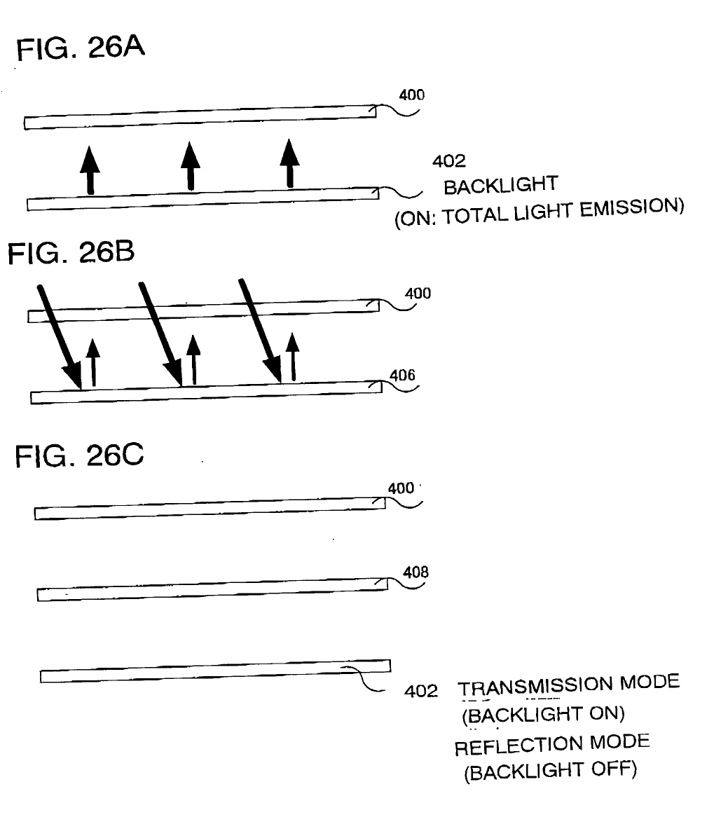

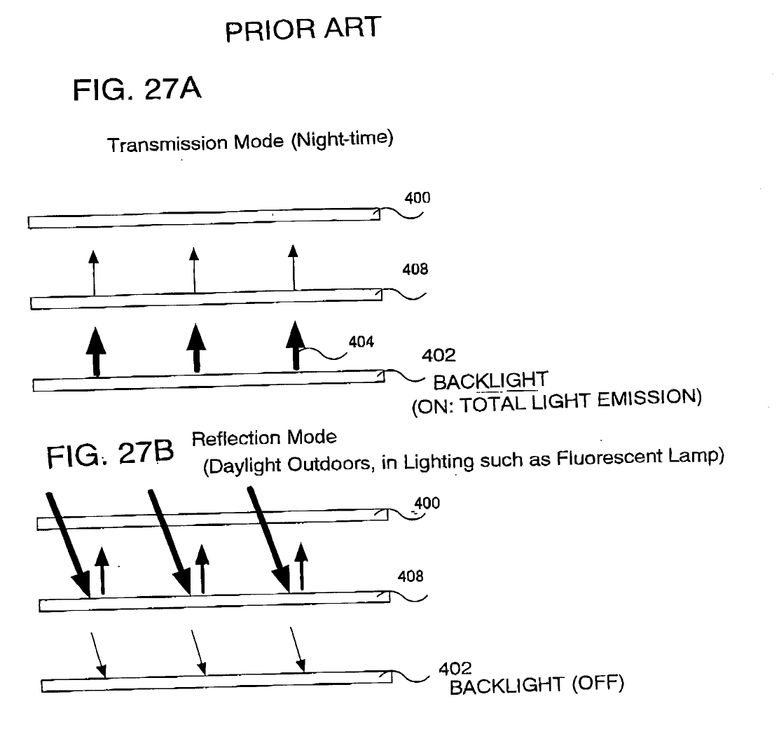

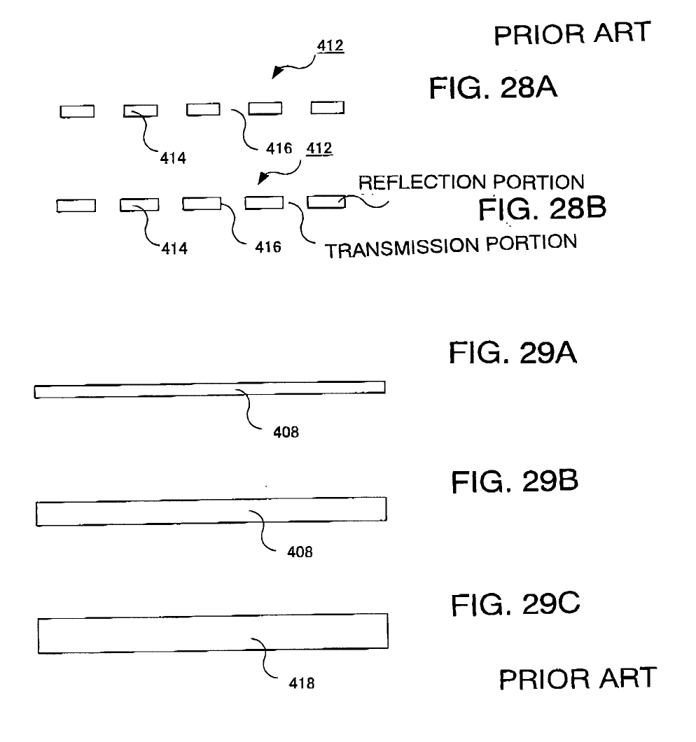

The lighting device for emitting light from the anode layer side is designed such that light is emitted from only opening portions 116 of the reflecting layer 104. Note that the entire reflecting layer 104 in which the opening portions 116 are formed composes a semi-transmission reflecting layer 154. Such a lighting device for emitting light from the anode layer side can be combined with liquid crystal panels which are described below and illustrated in FIGS. 23 and 24 to construct a liquid crystal display device.

(Embodiments 9 to 18)

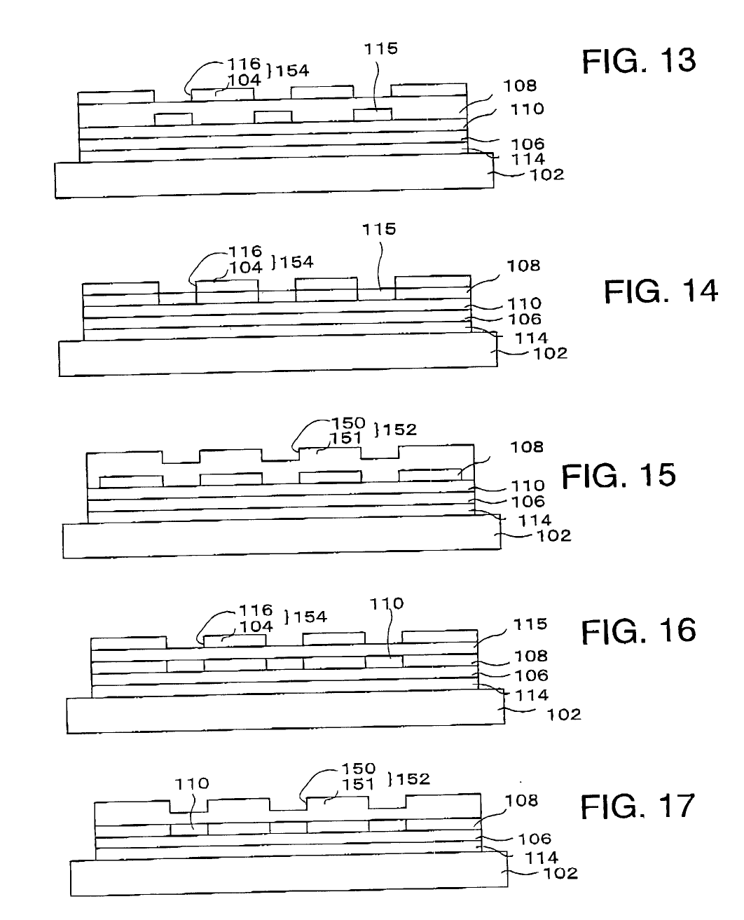

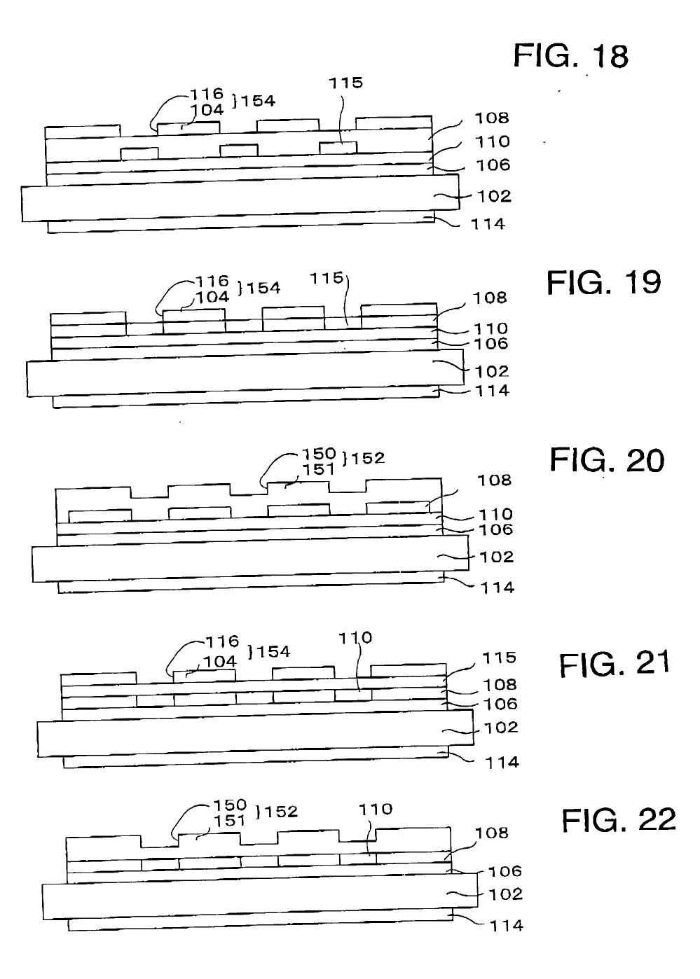

FIGS. 13 to 22 show the structures of lighting devices of the present invention to which a method of emitting light from a transparent cathode layer side (organic EL element illustrated in FIG. 3) is applied. Meanings of reference symbols in the respective drawings are indicated in the following tables 4 to 6.

TABLE 4

| | | | | Example | | | |
|---|---|---|---|---|---|---|---|
| | | | | 9 | 10 | 11 | 12 |
| | Composition | Thickness | | | | | |
| Substrate | Substrate | 0.1-1.1 | mm | 102 | 102 | 102 | 102 |
| Reflecting layer | Reflecting layer | 50-200 | nm | 114 | 114 | 114 | 114 |
| Anode layer | Transparent electrode | 100-200 | nm | 106 | 106 | 106 | 106 |
| Organic EL layer | Hole injection layer | 30-100 | nm | 110 | 110 | 110 | 110 |
| | Hole transporting layer | 10-40 | nm | 110 | 110 | 110 | 110 |
| | Light: emitting layer | 10-40 | nm | 110 | 110 | 110 | 110 |
| Transparent | Transparent first | 0.1-2 | nm | 115 | 115 | 150 | 115 |
| cathode | cathode layer | | | | | | |
| layer | Transparent second | 5-10 | nm | 115 | 115 | 150 | 115 |
| | cathode layer | | | | | | |
| | Transparent third | 100-200 | nm | 115 | 115 | *1 | 115 |
| | cathode layer | | | | | | |
| Insulating layer | Insulating layer | 100-200 | nm | 108 | 108 | 108 | 108 |
| Reflecting layer | Reflecting layer | 100-200 | nm | 104 | 104 | 151 | 104 |
| | | | | | (AI) | | |

TABLE 5

| | | | | Example | | | |
|---|---|---|---|---|---|---|---|
| | | | | 13 | 14 | 15 | 16 |
| | Composition | Thickness | | | | | |
| Substrate | Substrate | 0.1-1.1 | mm | 102 | 102 *2 | 102 *2 | 102 *2 |
| Reflecting layer | Reflecting layer | 50-200 | nm | 114 | 114 | 114 | 114 |
| Anode layer | Transparent electrode | 100-200 | nm | 106 | 106 | 106 | 106 |
| Organic EL layer | Hole injection layer | 30-100 | nm | 110 | 110 | 110 | 110 |
| | Hole transporting layer | 10-40 | nm | 110 | 110 | 110 | 110 |
| | Light emitting layer | 10-40 | nm | 110 | 110 | 110 | 110 |
| Transparent | Transparent first | 0.1-2 | nm | 150 | 115 | 115 | 150 |
| cathode layer | cathode layer | | | | | | |
| | Transparent second | 5-10 | nm | 150 | 115 | 115 | 150 |
| | cathode layer | | | | | | |
| | Transparent third | 100-200 | nm | *1 | 115 | 115 | *1 |
| | cathode layer | | | | | | |
| Insulating layer | layer | 100-200 | nm | 108 | 108 | 108 | 108 |
| Reflecting layer | Reflecting layer | 100-200 | nm | 151 | 104 | 104 | 151 |
| | | | (AI) | | | (AI) | |

*1 Possible even if it is not located.
*2 Transmission is required.

TABLE 6

| | | | | Example | |
|---|---|---|---|---|---|
| | | | | 17 | 18 |
| | Composition | Thickness | | | |
| Substrate | Substrate | 0.1-1.1 | mm | 102 *2 | 102 *2 |
| Reflecting layer | Reflecting layer | 50-200 | nm | 114 | 114 |
| Anode layer | Transparent electrode | 100-200 | nm | 106 | 106 |
| Organic EL layer | Hole injection layer | 30-100 | nm | 110 | 110 |
| | Hole transporting layer | 10-40 | nm | 110 | 110 |
| | Light emitting layer | 10-40 | nm | 110 | 110 |
| Transparent cathode | Transparent first cathode | 0.1-2 | nm | 115 | 150 |
| layer | layer | | | | |
| | Transparent second cathode | 5-10 | nm | 115 | 150 |
| | layer | | | | |
| | Transparent third cathode | 100-200 | nm | 115 | *1 |
| | layer | | | | |
| Insulating layer | Insulating layer | 100-200 | nm | 108 | 108 |
| Reflecting layer | Reflecting layer | 100-200 | nm | 104 | 151 (AI) |

In Embodiments 9, 10, 11, and 12, a substrate 102 is a polished smooth insulating substrate made of no alkali glass, plastic, or the like. Any substrate having a smooth property and an insulating property can be used. In addition, in Embodiments 14, 15, 16, 17, and 18, a substrate 102 is a polished smooth insulating transparent substrate made of no alkali glass, plastic, or the like. A reflecting layer 104 is a reflecting layer made of aluminum, silver, or the like. A dielectric multi-layer film total reflection mirror or the like can be also used. A transparent anode layer 106 is an ITO film formed by sputtering or the like. An insulating layer 108 is made of SiO₂, SiN, SiNxOy, or the like. An organic EL layer 110 is composed of a hole injection layer, a hole transporting layer, a light emitting layer, and the like. The hole injection layer can be formed by evaporation using CuPc (copper phthalocyanine) or the like. The hole transporting layer can be formed by for example an evaporation method using α-NPD (α-naphthylphenyldiamine) or the like. The light emitting layer can be formed by for example evaporation using Alq₃ (8-quinolinol aluminum complex) or the like. A transparent cathode layer 115 is composed of a first transparent cathode layer, a second transparent cathode layer, a third transparent cathode layer, and the like. The first transparent cathode layer can be formed by for example evaporation using LiF (lithium fluoride) or the like. The second transparent cathode layer can be formed by for example evaporation using aluminum or the like. The third transparent cathode layer can be formed by for example sputtering using ITO. In Embodiments 11, 13, 16, and 18, the third transparent cathode layer may be not formed.

As described above, the lighting device for emitting light from the cathode side is designed such that light is emitted only from the opening portions 116 of the reflecting layer 104 or holes with bottoms 150. Note that in FIGS. 13, 14, 16, 19, and 21, the entire reflecting layer 104 in which the opening portions 116 are formed composes the semi-transmission reflecting layer 154. In addition, in FIGS. 15, 17, 20, and 22, an entire reflecting layer 151 in which the holes with bottoms 150 are formed composes a semi-transmission reflecting layer 152. Here, the holes with bottoms 150 serve as the first and second transparent cathode layers. Thus, there is a characteristic that a process for the lighting devices illustrated in FIGS. 15, 17, 20, and 22 is simplified as compared with that for the lighting devices illustrated in FIGS. 13, 14, 16, 19, and 21.

These lighting device for emitting light from the cathode layer side can be combined with a liquid crystal panel which is described below and illustrated in FIG. 25 to construct a liquid crystal display device.

(Embodiment 19)

FIG. 23 shows an example in which a lighting device 308 for emitting light from the anode layer side as shown in FIG. 5 is combined with a liquid crystal panel 306. Liquid crystal 304 is sealed between an upper glass member 300 and a lower glass member 302 to construct the liquid crystal panel 306.

The lighting device 308 has the structure shown in FIG. 5, in which a substrate 301 and a sealing, substrate 312 made of SUS (stainless steel) or glass are airtightly bonded to each other by a sealing member 314. In sealing, the inner portion is filled with an inert gas such as nitrogen or argon. The EL element shown in FIG. 5 is formed on the inside surface of the substrate 310. It is constructed that light is emitted from the anode layer side, and the lighting devices of the embodiments as shown in not only FIG. 5 but also FIGS. 6 to 12 can be applied. Note that a dry agent 318 made of barium oxide or the like is provided here. Light is emitted from the anode (lower surface) side of the substrate.

(Embodiment 20)

FIG. 24 shows the structure in which an EL element formed to a substrate is sealed with a protective layer 320 made of metal oxide or the like. It is preferable that the metal oxide is SiNxOy such as SiN or SiO₂. The structure except for this is similar to that of Embodiment 19. It is a type in which light is emitted from the anode layer side, and the lighting devices of the embodiments as shown in not only FIG. 5 but also FIGS. 6 to 12 can be applied.

(Embodiment 21)

FIG. 25 shows the structure in which the lighting device for emitting light from the transparent cathode layer side as shown in FIG. 13 is combined with a liquid crystal panel. The lighting device has a structure in which it is sealed with the lower glass member 302 of the liquid crystal panel in the transparent cathode layer side. In this example, the lighting device having the structure shown in FIG. 13 and the lower glass member of the liquid crystal panel are integrally formed for incorporation. However, a sealing structure may be obtained by using a transparent substrate different from the lower glass member of the liquid crystal panel. Alternatively, the lighting device may be sealed with a transparent protective film and combined with the liquid crystal panel. In addition, the lighting devices shown in not only FIG. 13 but also FIGS. 14 to 22 can be applied.

According to the lighting device of the present invention, the through holes are formed in the reflecting layer and light emitted from the EL element is irradiated through the through holes so that light is hardly attenuated. Thus, in the case where the lighting device with the reflecting layer is incorporated in the liquid crystal display device and the resultant device is used as the semi-transmission liquid crystal display device when an optical design similar to that of a conventional product is made with respect to the reflection mode, the power of the backlight required for displaying a screen with a brightness equal to that of the conventional product can be greatly reduced in the transmission mode.

What is claimed is:

1. A lighting device with a reflecting layer comprising:
a semi-transmission reflecting layer in which a reflection portion and a transmission portion are formed; and
a light emitting element formed to a region corresponding to the transmission portion, wherein light emitted from the light emitting element is outputted through the transmission portion.

2. A lighting device according to claim 1, wherein the light emitting element is an EL element having an EL layer as a light emitting layer, and only the EL layer in a location corresponding to the transmission portion emits light.

3. A lighting device according to claim 1, wherein the light emitting element is an EL element having an EL layer as a light emitting layer, and the EL layer is formed in only a location corresponding to the transmission portion.

4. A lighting device according to claim 2, wherein the EL element includes: an anode layer and a cathode layer which are provided to sandwich the EL layer; and at least one of the anode layer and the cathode layer is not formed in a location corresponding to the reflection portion.

5. A lighting device according to claim 2, wherein the EL element includes: an anode layer and a cathode layer which are provided to sandwich the EL layer; and an insulating layer formed between at least one of the anode layer and the cathode layer and the EL layer in a location corresponding to the reflection portion.

6. A lighting device according to claim 5, wherein the transmission portion has a function of one of the cathode layer and the anode layer.

7. A lighting device according to claim 2, wherein the EL element includes an anode layer and a cathode layer for applying a voltage to the EL layer, and one of the cathode layer and the anode layer which are provided in a location corresponding to the transmission portion is separated by an insulating layer.

8. A lighting device according to claim 1, wherein the transmission portion has a plurality of through holes formed in the semi-transmission reflecting layer.

9. A liquid crystal display device comprising:
a liquid crystal panel; and
a lighting device provided on a rear surface of the liquid crystal panel, wherein the lighting device includes, a semi-transmission reflecting layer in which a reflection portion and a transmission portion are formed, and a light emitting element formed to a region corresponding to the transmission portion, and wherein light emitted from the light emitting element is outputted through the transmission portion and irradiated to the liquid crystal panel.

10. A liquid crystal display device according to claim 9, wherein the light emitting element is an EL element having an EL layer as a light emitting layer, and only the EL layer in a location corresponding to the transmission portion emits light.

11. A liquid crystal display device according to claim 10, wherein the liquid crystal panel has a lower glass member used as a sealing substrate for the EL element.
